(19) United States
(12) Patent Application Publication
(10) Pub. No.: US 2009/0301203 A1
(43) Pub. Date: Dec. 10, 2009

(54) Tool, Sensor, and Device for a Wall Non-Distructive Control

(75) Inventor: Marc Brussieux, Brest (FR)

Correspondence Address: PAULEY PETERSEN & ERICKSON, 2800 WEST HIGGINS ROAD, SUITE 365, HOFFMAN ESTATES, IL, 60169, US

(73) Assignee: ROBOPLANET, Gouezec (FR)

(21) Appl. No.: 11/919,370

(22) PCT Filed: Apr. 28, 2005
(86) PCT No.: PCT/FR2005/001085

§ 371 Date: Oct. 26, 2007

(51) Int. Cl. G01N 29/265

(52) U.S. Cl. 73/627; 901/1

(57) ABSTRACT

The invention relates to a tool for non-destructive inspection of a three-dimensional wall, the tool including a plurality of juxtaposed non-destructive inspection sensors. The sensors are mounted on a support for moving the set of sensors in common relative to the wall. The support is deformable for each of the sensors so that the sensors are movable relative to one another. Also provided are a constraint element for constraining the application face of each sensor to press individually against the wall and a sliding element for causing the application face of each sensor to slide against the wall.

### BACKGROUND OF THE INVENTION

1. Field of the Invention

The present invention relates to the non-destructive inspection of the state of large industrial structures such as, for example, ships, pipelines, or storage tanks.

2. Discussion of Related Art

Non-destructive inspection is traditionally performed by an operator manually applying a measurement probe against or close to the surface of the structure for inspection. The probe then emits acoustic, ultrasound, or electromagnetic pulses which propagate in the material of the structure and which are partially reflected by any fractures, welds, corrosion blemishes, walls, or non-uniformities. The probe receives these reflected signals and converts them into electrical signals that are displayed by an electronic device. The operator makes use of the display, e.g., for measuring the thickness of the material at the point where the probe is placed.

Unfortunately, current techniques are unsuitable for thoroughly scanning areas of several tens to several thousands of square meters (m²) in large industrial structures, such as the hulls of ships, for example.

Presently, operators only perform spot measurements, in the vicinity of the point where the probe is placed, occupying an area of a few square millimeters (mm²) to a few square centimeters (cm²). In order to inspect very large structures exhaustively at a regular sampling pitch in two dimensions of a few centimeters by a few centimeters, the operator would need to move the probe several million times, which is not possible. Present-day inspections can thus be very sporadic: large areas remain unscanned and a statistical risk is taken based on the assumption that the structure does not present any defect between two spaced-apart measurement points.

Furthermore, the work undertaken by the operator is difficult because it is often necessary to work elevated on scaffolding or suspended in the air by cords, or to dive under the hull of a ship, and present measurement devices do not make this work any easier as it is necessary to hold the probe in position while adjusting and observing the display on the device. This process must be repeated for a large number of measurement points. Inspections carried out using present means are therefore lengthy and difficult.

In addition, in the present technique, the measurement points are poorly identified in three dimensions: for example operators apply chalk marks on the points where they have applied the probe and then photograph those marks. However, such photographs are not sufficient for preparing a map of the structure: while they give approximate positions for the locations where measurements were performed, they do not enable those positions to be accurately quantified in three dimensions.

To automate inspections, robotic devices have been devised, comprising a manipulator arm that automatically moves the measurement probe, as described in document FR-A-2 794 716. However, these systems are characterized by the fact that they are guided on rails or on support points. When the manipulator arm has completed moving the probe over the entire volume that it can reach mechanically, it is necessary to move the support rail or the support points in order to cover another zone. These devices are thus not self-contained and the repeated displacement of the support point or rail constitutes a handicap when the area for inspection is very large.

Document WO 00/73739 describes a system for measuring the thickness of material in a zone under examination. In one embodiment, the system can comprise a mobile unit that moves two rows of thickness-measuring sensors under the control of a remote operator, together with a system for determining the position of the mobile unit. Another embodiment uses a sensor carried in a sling by a human operator. The sensor is an acoustic sensor filled with a coupling medium enabling sound waves emitted from broadband transducers to propagate towards an outlet face. The coupling medium is liquid, fluid, such as water or a gel, or even solid, and the outlet face is provided with a flexible membrane for separating the coupling medium from the outside medium. To take a measurement on a structure that is not submerged in a fluid, the membrane is pressed against the structure for measurement with sufficient pressure to ensure that the outlet face of the sensor is well matched to the surface of the structure and is well coupled thereto without using a coupling medium. In order to well match the membrane to the structure for measuring, a pump is provided for controlling the pressure of the coupling medium against the membrane. When measurements are performed on a structure that is immersed in a fluid, the membrane can be omitted, with the fluid acting as the coupling medium.

In practice, the measurement system is difficult to use for performing measurements on three-dimensional walls of large size.

The membrane that is pressed against the wall wears quickly when in contact with roughnesses thereon.

When a plurality of sensors are provided, it is also necessary for each of the sensors to be properly pressed against the wall, even though for a three-dimensional wall the exact position of the point where each sensor needs to be positioned is not known in advance, and this changes each time the sensor is moved into a zone adjacent to the zone where the preceding measurement was taken. Thus, in practice, such a measurement system is difficult to automate with a plurality of sensors and can be operated only by a human operator carrying, moving, and manually applying a single sensor against the wall, as is described in that document.

This measurement system thus presents the above-described drawbacks of manual systems in which it is the human operator who holds the measurement sensor against the wall.

### SUMMARY OF THE INVENTION

An object of the present invention is to remedy drawbacks that are inherent in the state of the art by proposing a tool, a sensor, and apparatus for non-destructive inspection making it possible to simultaneously move and apply the sensor against the wall or the structure for inspection, and to do so over large wall areas and large industrial structures such as ships, for example.

The invention provides a tool comprising a plurality of sensors mounted on a support which is both deformable so that the sensors can move relative to one another, and suitable for moving the set of sensors along the wall.

Constraint element or constraint means is or are provided so that the application face of each sensor is placed against the wall, and a sliding element or sliding means is or are also provided for sliding the application face of each sensor over the wall.

Each sensor is thus pressed individually against the wall with two degrees of freedom thereagainst, thus enabling it to be moved over the wall.

The constraint element or means and the sliding element or means are specific to each sensor, for example, and they may for example constitute a cushion of fluid injected between the application face of the sensor and the wall.

The tool enables various of the sensors to be pressed against a three-dimensional wall that may have any curvature. The support allows the sensors to follow the curvature of the wall and accommodate the differences in the heights of the sensors above a theoretical plane of the tool, where said differences are due to the differences in the height of the wall relative to said theoretical plane.

The invention also provides an apparatus for non-destructive inspection of structures. The apparatus comprises a measurement unit or tool having one or more non-destructive inspection sensors, and a mobile robot capable of moving the unit over the walls of said structures. The unit and the robot include an element or means for adhering to the walls of said structures, an element or means for sliding or running on the walls, without being guided mechanically by apparatus secured to the walls, an element or means for locating position in three dimensions while the unit is moving, electronic calculation and interface means co-operating with the sensors of the unit that are capable of taking measurements on the structure, and a communication element or means enabling the measurements to be transmitted to a remote computer, and enabling commands to be received from a remote computer.

By way of example, the unit or tool includes a support of lightweight and flexible material capable of matching the shapes of the structure, e.g., a mat of plastics foam or a set of flexible blades, with the sensors being secured to the support.

In one embodiment, the unit or tool has magnets and the robot has magnetized wheels serving to hold the tool pressed against the structure, providing the structure can attract a magnet as is the case for the steel of the hulls of ships, otherwise the unit and/or the robot includes a peripheral skirt and suction apparatus for removing the air between the unit and the structure by suction. A preferred disposition for the magnets comprises making the cases for the sensors out of magnetized material. These dispositions present the advantage of the sensors being pressed spontaneously by their own magnetization against the structure, with magnetic force replacing the application force applied by a human operator.

The unit or tool is preferably provided with skids enabling it to slide over the surface of the structure.

In an embodiment, the tool is moved over the surface of the structure by means of a robot that has wheels or legs and is capable of adhering to the structure, e.g., by means of magnets, magnetized wheels, or pneumatic suction cups.

In a simplified version of the invention, the tool may be moved over the structure by the hand of an operator.

The tool may have a row of about ten to about one hundred sensors spaced apart form one another at intervals of 1 centimeter (cm) to 10 cm.

The sensors are preferably feelers for non-destructive inspection by ultrasound, enabling the thickness of the material to be measured or enabling welds to be inspected in the vicinity of a feeler. Alternatively, they may be eddy current sensors. When the invention is used on the hulls of ships, the sensors can be used, for example, to measure the thickness of the sheets constituting the hull of a ship.

The tool that is moved by hand, the tool that is moved by the robot, or the robot itself can carry interface electronics for the sensors and a computer for managing the device. The computer takes the measurements and transmits them to a remote computer via communications elements or means preferably of the type involving a radio link. From the remote computer it receives instructions and serves to position and control the robot and the unit over the surface of the structure.

The measurement method using the device of the invention comprises or consists in moving the tool over the entire area of the structure for inspection such as by means of the robot or by hand, in a direction that is orthogonal to its long dimension, like a broom head. While moving, and for each position of the tool, each of the sensors takes a measurement of the point it overlies. The spacing between the sensors, the speed of advance of the tool, and the rate at which measurements are taken are determined so that the structure over which the tool moves is inspected at a sampling pitch that is precise over the entire length of the path, e.g., a pitch of centimeter order.

The position of the robot, or of the tool that is moved by hand in three dimensions, is measured by a device that is known in the state of the art and that is sold, for example, by the manufacturer TRIMBLE of 645 South Mary Avenue; Sunnyvale; Calif., USA 94088-3642 and is referred to as an active-target robotic total station. That type of apparatus, which is traditionally used in making topographic measurements, comprises a stationary reference station, e.g., standing on the ground at a distance of about 10 meters (m) to 100 m from the structure for inspection, and a light emitter referred to as an “active target” that is placed on the robot or on the tool. The reference station points continuously and automatically to the emitter and delivers its three-dimensional position with centimeter accuracy at a rate of about once per second. The position of the robot or of the tool as measured by such positioning means while it is moving over the structure under inspection is transmitted by the reference station to the remote computer in order to be recorded together with the measurements being transmitted by the robot over transmission means that are preferably of the radio link type. The remote computer thus knows the three-dimensional position of the tool and can generate and transmit to the robot movement commands for guiding the robot along a prescribed path on the structure.

The remote computer thus has available in real time all of the measurements and also the positions on the structure at which the measurements were taken. Advantageously, it processes and displays the data for an operator in the form of ergonomic views. Preferred types of representation are of the A-scan type, or of the real type, or of the C-scan type. Another type of preferred representation draws the shape of the structure as measured in three dimensions on the screen of the computer, and marks on the shape the measurements that are taken. These representations may contain lines tracing contours of constant value, and can utilize a false color encoding scheme to reveal measurement points that are abnormal, or can display differences observed relative to measurements previously taken.

When the tool is manually moved over the surface of the structure under inspection, the thickness measurements can be displayed directly on the tool by a visual display, e.g., of the light emitting diode (LED) or a liquid crystal screen type.

In a variant of the invention for inspecting structures that are under water, the robot and the unit are made waterproof. The above described positioning system is replaced by an acoustic positioning system having a base that is long, short, or ultra-short, and the radio communications are replaced by wire communications or acoustic communications that are known in the state of the art. In this variant, the above-described injection of water is not needed.

### BRIEF DESCRIPTION OF THE DRAWINGS

The invention can be better understood on reading the following description given purely by way of non-limiting example and with reference to the accompanying drawings, in which:

FIG. 1 is an overall perspective view of inspection apparatus in accordance with one embodiment of the invention;

FIG. 2 is a diagrammatic perspective view of a robot fitted with an inspection tool in accordance with one embodiment of the invention and suitable for moving over a wall for inspection;

FIG. 3 is a diagrammatic perspective view of a first embodiment of a tool suitable for use in the apparatus in accordance with the invention;

FIG. 4 is a diagrammatic cross-section view of a second embodiment of a tool suitable for use in an apparatus in accordance with the invention;

FIG. 5 is a diagrammatic cross-section view of a first embodiment of a sensor in accordance with the invention;

FIG. 6 is a diagrammatic cross-section view of a second embodiment of a sensor in accordance with the invention;

FIG. 7 is a diagrammatic horizontal section through the sensor of FIG. 6;

FIG. 8 is an electronic block diagram of a measurement data computer unit present on the tool or the robot;

FIG. 9 is a diagrammatic perspective view of a third embodiment of a tool suitable for use in an apparatus in accordance with the invention; and

FIG. 10 is a diagrammatic perspective view of a fourth embodiment of a tool suitable for use in an apparatus in accordance with the invention.

### DETAILED DESCRIPTION OF THE INVENTION

A method of taking measurements that is performed by using a non-destructive inspection apparatus of the invention is described below and shown in the figures for the example of the steel hull of a ship.

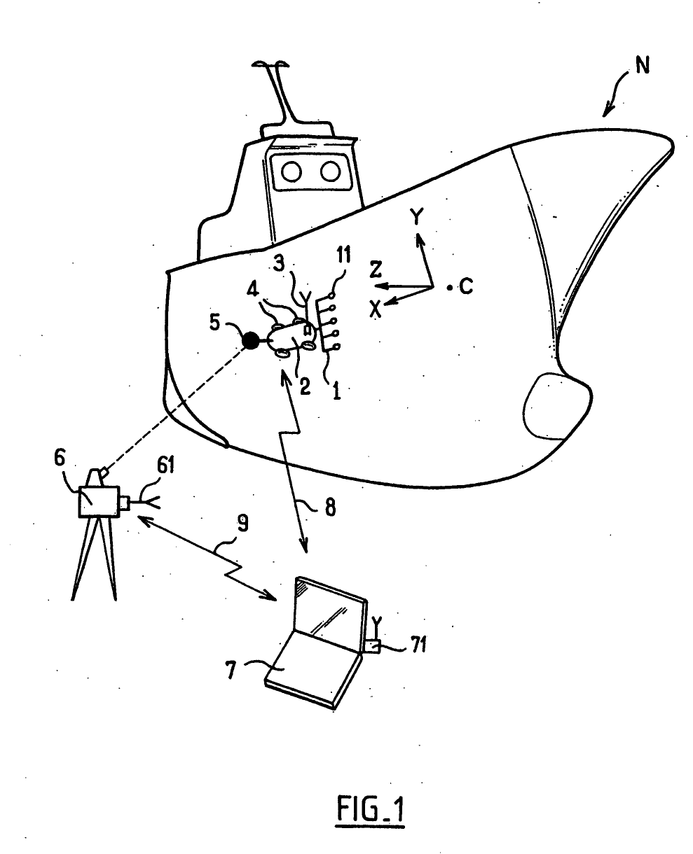

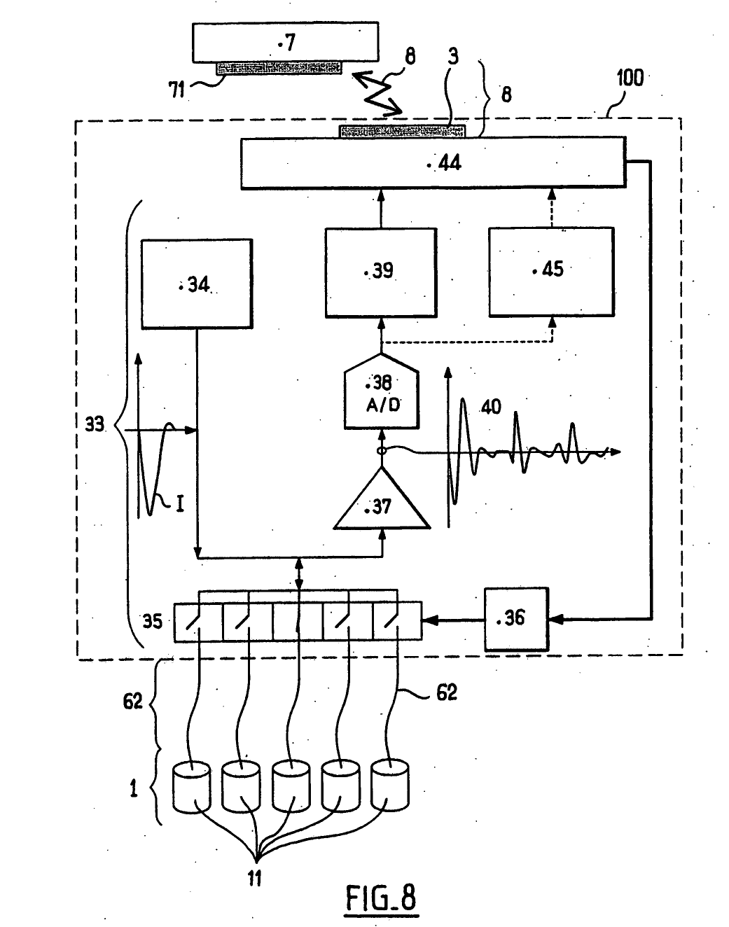

In FIG. 1, the apparatus comprises a measurement unit or inspection tool 1 comprising a plurality of measurement sensors 11 that is moved, e.g., towed, by a robot 2 rolling on the hull C of the ship N in a lengthwise direction X and a widthwise direction Y, adhering to the hull by means of magnetized wheels 4, the direction Z oriented upwards relative to the hull C being perpendicular to the directions X and Y. By way of example, the sensors 11 are sensors for measuring local thickness, using interface circuits and an onboard computer 44, as described below with reference to FIG. 8, to generate thickness data that is referred to below as measurement data.

The robot 2 and/or the inspection tool 1 include a measurement data transmitter or transmission means 3 for transmitting data from the sensors 11 to a computer 7 that is remote from the tool. When the tool is moved by the robot 2, the transmitter 3 is, for example, a wireless transmitter 3, e.g., having an antenna, that enables a radio link 8 to be established with the remote computer 7 that is likewise provided with a corresponding transmitter 71.

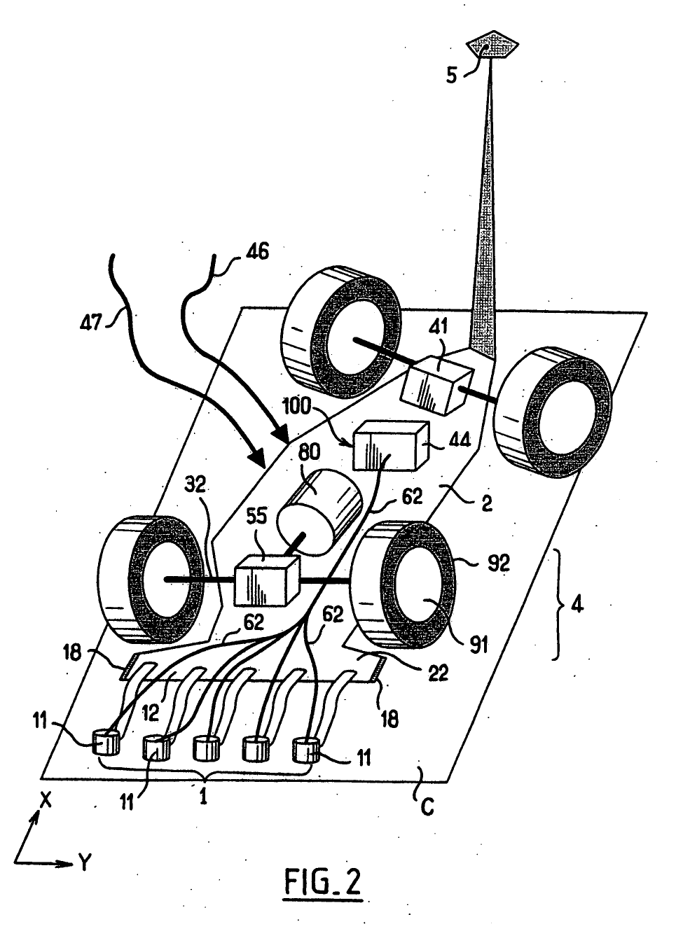

FIG. 2 shows the robot 2 comprising a drive motor 80 that is preferably electrically connected to its magnetized wheels 4 via mechanical transmitter or transmission means 32. Each of these wheels 4 preferably includes a magnetized central portion 91 generating a magnetic force that presses the wheel against the hull C. About the central portion 91 there is fixed a tire 92 such as of flexible polymer material to prevent the wheel slipping on the hull C. The robot preferably includes a steering element or means 41 for steering its wheels and differential transmission stages 55 to enable it to change its path and its travel direction on the hull C, like a motor car.

The robot 2 and/or the inspection tool 1 also includes a position tracking element or means 5 for tracking the position of the tool 1 on the hull C. In FIGS. 1 and 2, the robot 2 includes, for example, a light emitter 5 or other identification member 5, whose position is continuously detected by a positioning station 6 secured to land. The stationary positioning station 6 is provided with a transmitter or transmitter means 61, e.g., via a wireless radio link 9 for transmitting the measured position of the robot to the remote computer 7. The remote computer 7 uses the transmitter 71 and the link 8 to send commands to the robot 2 enabling it to direct the robot 2 and the tool 1 to follow a known prescribed path over the hull of the ship.

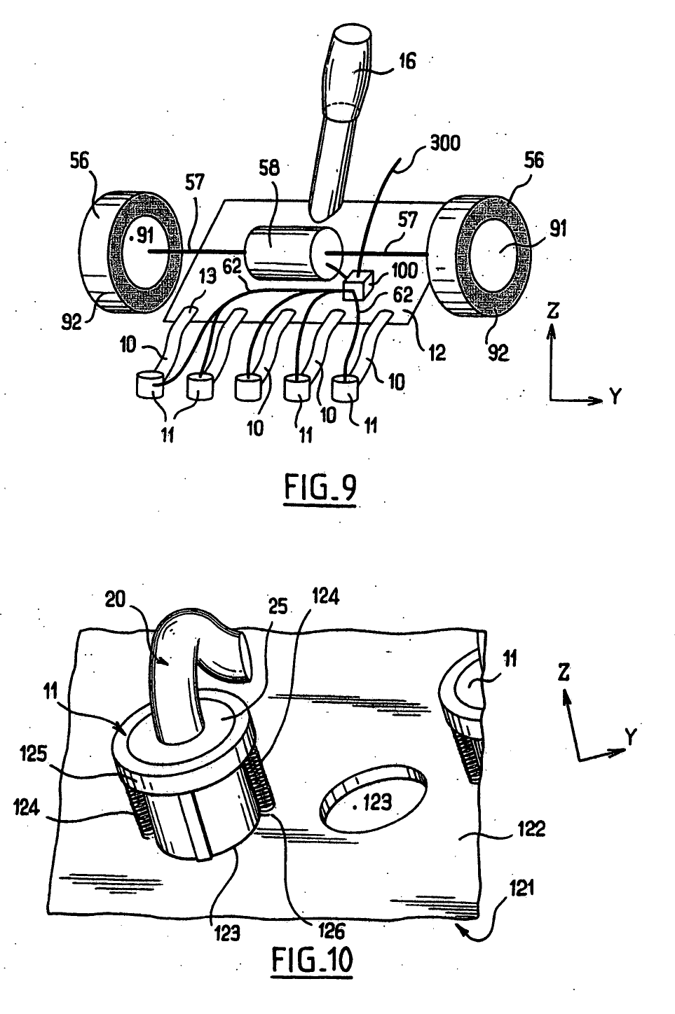

When the tool 1 carrying the sensors 11 is manually moved by a human operator over the surface of the hull C, the measurement data transmitter 3 may comprise, for example, a wire element 300 connecting the unit 100 to a computer 7 carried by the operator or to a computer 7 situated at some other location, e.g., on the deck of the ship, as shown on FIG. 9.

In the embodiment of FIG. 9, the tracking element or means 5 for tracking position comprises, for example, one or more encoder wheels 56 in contact with the hull C, oriented against the hull C so as to rotate thereon while the tool is moving over the hull C. By way of example, each wheel 56 comprises a magnetized central portion 91 creating a magnetic force pressing the wheel against the hull C. Around the central portion 91 there is secured a tire 92, e.g., of flexible polymer material, that serves to prevent the wheel from slipping on the hull C. The axel 57 of the wheels 56 is mounted on a rigid portion 12 of the tool, and for example two wheels 56 are provided on either side of the width of the base 12. The wheels 56 are connected to an encoder 58 that supplies the unit 100 with the rotary position(s) of the encoder wheel(s) 56, together with the number of revolutions that have occurred since an initial position, thus enabling the position of the tool 1 to be determined relative to said initial position. The various positions of the tool 1 as identified in this way can be transmitted to the computer 7 and recorded in association with the measurement data that is obtained in the computer 7. This embodiment can be used equally well by a human operator or by the robot 2.

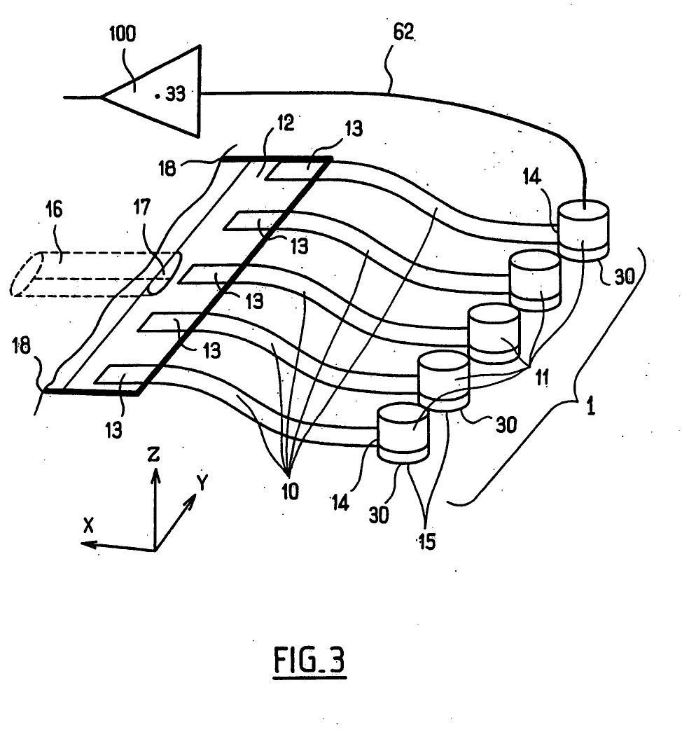

In the embodiment of FIG. 3, the inspection tool 1 has n sensors 11 (where n≧2 and n=5, by way of example, in FIG. 3), and a set of n elongated and flexible spring blades 10 forming n arms 10 each having a first end 13 and a second end 14 that is remote from the first end 13 and that is flexibly movable relative thereto. Each sensor 11 is secured to the second end 14 of an arm 10. The first ends 13 of the arms 10 are secured side by side across the width of a common base 12. The sensors 11 are thus disposed side by side widthwise with their application bottom faces 30 facing in the same downward direction so as to face towards the hull C, the blades extending substantially in the same longitudinal direction X. The connections to the first and/or second ends 13, 14 of the arms 10 may present flexibility or a degree of freedom in pivoting or of the ball-joint type, to allow each sensor 11 to pivot by a small amount relative to the base 12.

The base 12 serves to commonly move the sensors 11 over the hull C, and is for example rigid while cooperating with the arms 10 to form a support that is deformable.

In the embodiment of FIG. 9, the tool 1 may include a handle 16 or any other grip element secured to the base 12 and more generally to the sensor support 11, e.g., extending the base 12 from its side opposite the blades 10 so that a human operator can take hold of the tool 1 and take measurements using the sensors 11 while manually moving the tool 1 together with all of the sensors 11 simultaneously along the hull C. For example, the handle 16 is removably mounted on the base 12, with corresponding separable mounting means 17 being provided on the base 12.

In FIG. 3, the tool 1 may also include a mount or means 18 for being mounted on the robot 2, which means may likewise be separable. In FIG. 2, the width of the base 12 is located at the rear 22 of the robot 2. Where appropriate, the means 16 and 18 are identical and enable the tool 1 to be grasped manually and also to be handled by the robot 2.

The mount provided on the base can serve both for securing the base to the robot and for securing the manual grip element.

The resilience of the flexible blades 10 allows them to bend and relax individually so that the sensors 11 are held and movable relative to one another while nevertheless closely following the outlines of the hull C while the tool 1 is moving over its surface, similar to a set of fingers.

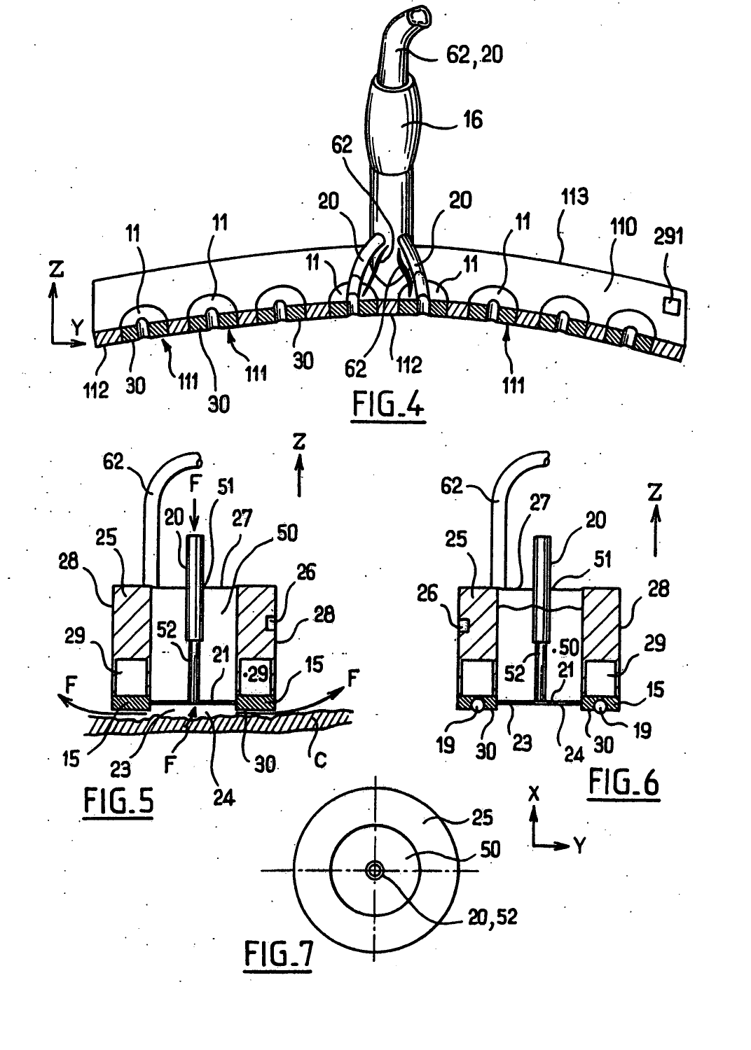

In the embodiment of FIG. 4, the inspection tool 1 comprises a deformable mat 110 having the n sensors 11 secured thereto. By way of example, the sensors 11 are secured by inserts in the mat 110. The sensors 11 have their application bottom faces 30 located in respective openings 111 in the mat. The openings 111 are distributed side by side widthwise over a common bottom surface 112 of the mat 110 that is to face towards the hull C. The bottom faces 30 of the sensors 11 lie flush with the bottom surface 112 of the mat 110, for example. The bottom faces 30 of the sensors 11 could equally well project a small distance from the bottom surface 112 through the openings 111. The mat 110 forms a flexible housing for the sensors 11 and can be formed by a piece of deformable fabric or plastics material suitable for sliding over the hull of the ship while fitting closely to its shapes. The hoses 20 and the cables 62 that are described below for the sensors 11, pass through the housing 110. In this embodiment, the sensors 11 may include magnets as described below, or the housing 110 may include one or more magnets 291 that are distributed therein. A manual grip element 16 or a mount 18 are provided on the top face 113 of the mat 110.

In the embodiment of FIG. 10, the inspection tool 1 comprises a base 12, e.g., a base that is planar and rigid, having a bottom face 121 for facing towards the hull C, and a top face 122. The base 12 has holes 123 for receiving sensors 11. Traction springs 124 connect the top portion 125 of the sensors to the edge 126 of the hole 123 receiving them. By way of example, the top portion 125 is formed by a shoulder of a case 25 containing a sensor 11. The top ends of the springs 124 are secured, for example, under the top portions 125, while the bottom ends of the springs are secured to the edges 126, for example. The sensors 11 project from the bottom face 121 by a predetermined amount when the base 12 is horizontal. The springs 124 constrain the sensors to move from the top face 122 towards the bottom face 121. When a tool 1 is applied to the hull C, the application bottom face 30 of each sensor 11 is applied to the hull C against the force exerted by the springs 124 from the base 12 on the sensor 11 that is guided in the hole 123.

In the various embodiments of the tool 1, the elements or means 16 or 18 may be hollow and may include passages for making external connections to the tool 1, for example in the embodiments described below, hoses 20 for feeding the sensors 11 with fluid, electric cables 62 for connection to the sensors 11, and the transmitter 3 when they comprise a wired connection, as shown by way of example in FIG. 4.

In the embodiment in FIG. 5 and in the embodiment of FIGS. 6 and 7, a sensor 11 has a case 25 with a top face 27, a bottom face 30 for application against the hull C, and a side face 28 extending between the top and bottom faces 27 and 30, with the case 25 being generally in the form of a circular cylinder, for example. The case 25 defines a chamber in which there is secured a member 50 for non-destructive measurement of a predefined physical quantity of the wall of the hull C, for example its thickness in the Z direction. This measurement member 50 may comprise, for example, an ultrasound transducer, formed by a piezoelectric element converting an electrical current into pressure waves in the manner described below, the sensor then being referred to as an ultrasound feeler. The measurement member 50 includes an output or speaker bottom face 21 facing towards the application bottom face 30 and through which it emits waves towards said face 30 and the underlying hull C. By way of example, the side face 28 of the case 25 may include a mount or means 26 to enable the case to be mounted individually at the second end 14 of an arm 10, said individual mounting means 26 being constituted, for example, by a tapped hole 26 enabling the sensor 11 to be secured to the arm 10 that supports it. Variants could have other individual mount or mounting means on the sensors 11.

The case 25 is magnetized or includes a magnet 29 for holding the sensor against the steel hull C via its face 30. The magnetization of the cases of the sensors 11 ensures that they adhere to and are held in position on the surface of the structure under inspection during measurement. The magnet 29 may be provided, for example, around the member 50, close to the bottom face 30.

The sensor 11 includes a bottom skid 15 for sliding and protection purposes, forming the application bottom face 30 and enabling the sensor 11 to slide over the hull C. In the particular circumstance of using ultrasound non-destructive inspection feelers, the skids 15 are preferably secured under the magnetized cases 25 of the feelers 11 so that said cases 25 can slide by means of their skids 15 on the hull C under inspection in spite of being retained on the hull C because they are magnetized.

The skid 15 and the application bottom face 30 include an opening 24 situated in front of the speaker face 21 of the sensor 11. The speaker face 21 of the sensor 11 is rigid and set back from the application bottom face 30, with the set back being less than or equal to one millimeter, for example.

A fluid F, such as water, for example, is injected into the opening 24 and the space 23 between the speaker face 21 and the application face 30. The fluid F situated in the space 23 allows waves to propagate between the speaker face 21 and the wall of the hull C. The skids 15 may be made of a material that is sufficiently flexible, e.g., a felt, for it to be partially flattened by the magnetic force of the magnetized case 25 pressing it against the hull C for inspection, and can thus act as a gasket to retain the water that is injected into the space 23 situated between the sensor 11 and the surface of the hull C for inspection.

An external injection hose 20 brings a flow of fluid F into the space 23 between the speaker face 21 of the sensor 11 and the bottom face 30 for application towards the hull C for inspection. A hose 20 is provided for each of the sensors 11. The external hose 20 is connected for example to a feed hole 51 provided, for example, in the top face 27 of the face 25. The measurement member 50 includes, for example, a leaktight passage 52 going from the feed top hole 51 to the opening 24 and the space 23 and in which the end of the hose 20 is secured, e.g., about half-way up in FIGS. 5 and 6.

The pressure of the fluid injected into the space 23 through the bottom opening 24 from the sensor 11 is great enough to push the bottom face 30 and the skid 15 back a little above the wall of the hull C against the magnetic force urging the case 25 against said wall, thereby creating a gap between the bottom face 30 and the hull C through which the fluid F escapes, as represented by arrows in FIG. 5. The sensor 11 can thus slide on the fluid passing between said application bottom face 30 and the hull C. A fluid cushion is thus formed in the space 23 and between the application face 30 and the hull C, with the fluid being constituted by water, for example, and serving both for coupling purposes and for lubrication purposes.

In a variant, as shown in FIG. 6, the skid 15 further includes a gasket 19 projecting from its bottom face 30. By way of example, this gasket is made of a flexible material such as rubber.

The case 25 of each sensor or feeler 11 includes an external electric cable 62 for transmitting signals between interface circuits 33 of a unit 100 of the robot or of the tool 1, and the measurement member 50, as described below. The ultrasound measurement members 50 are conventionally made by numerous manufacturers, for example the supplier IMASONIC S.A.; 15, rue Alain Savary-25000 Besançon, FRANCE. For example, they are of a type that is not the phased array type and they are selected to have a diameter of centimeter order. Variants could include ultrasound feelers of square or circular shapes and of dimensions lying in the range 0.5 cm to 10 cm depending on the sought measurement precision and on whether or not it is decided to use phased array feelers. The number of sensors preferably lies in the range 8 to 64, thus giving the tool 1 a measurement width that lies in the range 20 cm to 2 m.

The ultrasound pulses emitted by the members 50 of the feelers 11 preferably have a center frequency F0 of about 5 megahertz (MHz) and a bandwidth B of about 3 MHz. In order to improve measurement precision, especially with metal structures, it is possible in a variant of the invention to increase the center frequency F0 up to 15 MHz. Similarly, in order to perform measurements in materials that are more absorbent than steel, e.g., plastics, composites, or concrete, it is preferable in another variant of the invention to reduce the center frequency F0 to smaller values, typically in the range 100 kilohertz (kHz) to 1 MHz in order to increase the amount of energy which is emitted and thereby better penetrate into said absorbent materials. The relative bandwidth B/F preferred in the invention lies in the range 40% to 60%.

FIG. 8 is a block diagram of the electronics of the unit 100. This unit 100 serves to obtain measurement data from the sensors 11. The unit 100 may be provided on the tool that is moved by hand as shown in FIG. 9, on the tool that is moved by the robot, or on the robot, as shown in FIG. 2. The interface circuits 33 of the unit 100 include a generator 34 of short electrical pulses I of amplitude that is preferably greater than 200 volts (V) and of duration that is preferably shorter than 100 nanoseconds (ns), a multiplexer/demultiplexer 35 controlled by an addressing circuit 36, itself controlled by the computer 44, serving to send said electrical pulses I sequentially to all of the members 50 of the sensors 11 of the tool 1 at a sequencing speed of the order of 100 sensors per second, for example. At a given instance, the member 50 of one of the sensors 11 of the tool 1 is selected by the addressing circuit 36 and receives the electrical pulse I coming from the generator 34 which is directed thereto by the multiplexer/demultiplexer 35, which pulse it then emits via its speaker face 21 in the form of an ultrasound pulse of known waveform into the wall of the hull C. The sound signals echoed by the wall of the hull C are converted by the member 50 of the sensor 11 during the several tens to several hundreds of microseconds that follow the emission instant into electrical signals 40 that are returned by the cable 62 and by the multiplexer/demultiplexer 35 to an amplifier 37. Thereafter the addressing circuit 36 causes the multiplexer/demultiplexer 35 to switch to the next sensor 11 of the tool 1. The signals 40 amplified by the amplifier 37 are transformed into digital signals by an analog to digital converter 38 from which they emerge in the form of a sequence of digital samples preferably encoded on more than 10 bits with sampling at a frequency that is preferably greater than 10 MHz. These digital samples coming from the converter 38 are preferably processed digitally by a dedicated digital processor circuit 39 that may be of the application specific integrated circuit (ASIC) type, or of the programmable logic array (PLA) type, or of the digital signal processor (DSP) type. From the digital samples, the circuit 39 extracts a value for the thickness of the wall at the point where the sensor 11 was located at the instant the ultrasound pulse was emitted. A variant of the invention comprises or consists in storing the digital samples leaving the converter 38 temporarily in a memory 45 and then in causing them to be processed by the onboard computer 44. Once the thickness value has been calculated by the dedicated circuit 39 or the computer 34, it is transmitted by the computer 34 via the transmitter 3 to the remote computer 7.

When the computer 44 is provided on the robot 2, this computer 44 receives driving instructions from the remote computer 7 via the transmitter 71 and the receiver 3, and it executes these instructions, e.g., by acting on its propulsion and steering means 55 and 41. The robot 2 may be powered by an electric cable 46 and with pressurized fluid F by a hose 47 in order to feed the water injection hoses 20 of the sensors 11 with water.

1. A tool for non-destructive inspection of a three-dimensional wall having a curvature, the tool comprising a plurality of juxtaposed non-destructive inspection sensors each containing a member for measuring at least one predefined physical quantity of the wall and including a face for application against the wall for inspection,
the tool comprising:
the sensors are mounted on a support for moving the sensors in common relative to the wall;
the support is deformable to enable the sensors to be movable relative to one another to follow the curvature of the wall; and
constraint element to individually constrain the application face of each sensor against the wall, and a sliding element to slide the application face of each sensor to slide against the wall.

2. A tool according to claim 1, wherein the support comprises a rigid base for moving the of sensors in common relative to the wall, and a plurality of individually deformable arms connecting the base to respective ones of the plurality of sensors.

3. A tool according to claim 2, wherein the deformable arm comprises an oblong resilient blade extending from the base to the sensor.

4. A tool according to claim 1, wherein the support comprises a deformable mat to which the sensors are secured.

5. A tool according to claim 1, wherein the support comprises:
a base for displacing the plurality of sensors in common, the base comprising a bottom face beneath which the sensors project at least via their respective application faces; and
a prestress element individually connecting the sensors to the base to constrain the application face of each sensor to move away from the bottom face of the base towards the wall.

6. A tool according to claim 5, wherein the prestress element comprises at least one spring retaining each sensor (11) individually to the base.

7. A tool according to claim 1 and wherein the wall comprises a metal, wherein the constraint element comprises at least one magnet that is attracted towards the metal wall.

8. A tool according to claim 1, wherein the constraint element is situated inside the sensor.

9. A tool according to claim 4 and wherein the wall comprises a metal, wherein the constraint element comprises, within the mat and outside the sensors, at least one magnet for attraction towards the metal wall.

10. A tool according to claim 1, wherein the sliding element comprises an injection element for injecting a fluid through an opening provided in the application face of each sensor, going outwards from said application face and against the constraint element.

11. A tool according to claim 1, wherein the constraint element comprises at least one suction cup.

12. A tool according to claim 1, wherein the sliding element comprises a sliding skid situated on the application face of each sensor.

13. A tool according to claim 1, additionally comprising a manual grip.

14. A tool according to claim 1, additionally comprising a mount enabling it to be mounted on a displacement robot.

15. A tool according to claim 1, additionally comprising a tracking element enabling its position in three dimensions to be tracked.

16. A tool according to claim 15, wherein the position tracking element comprises at least one encoder wheel for rolling on the wall.

17. A tool according to claim 1, wherein the sensors are connected to an unit for delivering measurement data from signals delivered by the measurement members.

18. Apparatus for non-destructive inspection of a three-dimensional wall, the apparatus comprising:
at least one mobile robot provided with means for adhering to the wall and for moving thereover;
at least one inspection tool according to claim 1 and mounted on the robot;
a position tracking element for tracking the three-dimensional position of the robot and/or of the tool;
an unit for providing measurement data from the signals from the measurement members of the sensors;
a measurement data transmitter for transmitting the measurement data to a remote computer; and
a position transmitter for transmitting the three-dimensional positions obtained by the position tracking element to the remote computer.

19. The apparatus according to claim 18, wherein the position tracking element comprises an identification member secured to the robot and/or to the tool, and at least one stationary positioning station provided with a detector for detecting the identification member.

20. A sensor for non-destructive inspection of a three-dimensional wall, the sensor comprising a case containing at least one member for measuring at least one predefined physical quantity of the wall, and including a face for application against the wall for inspection, the sensor comprising:
a constraint element to constrain the application face against the wall; and
a sliding element to slide the face against the wall.

21. A sensor according to claim 20 and wherein the wall comprises a metal, wherein the constraint element comprises at least one magnet for attraction towards the metal wall.

22. A sensor according to claim 20, wherein the sliding element comprises an injection element for injecting a fluid through an opening provided in the application face outwards from said application face and against the constraint element.

23. A sensor according to claim 22, wherein the case defines a chamber containing the measurement member and opening out into the opening in the application face, and includes a hole for introducing fluid into the chamber and up to said opening.

24. A sensor according to claim 23, wherein a fluid feed passage extends through the measurement member from the hole towards the opening in the application face.

25. A sensor according to claim 24, wherein the measurement member is secured inside the case close to a top face thereof, remote from the application bottom face, the hole being provided in the top face.

26. A sensor according to claim 20, wherein the sliding element comprises a sliding skid situated on the application face.

27. A sensor according to claim 26, wherein the sliding skid comprises a sealing gasket around the opening in the application face.

28. A sensor according to claim 20, wherein the constraint element comprises at least one suction cup.

29. A sensor according to claim 20, wherein the case includes, on an outside face other than the application bottom face, an individual mounting element for connecting the sensor case (25) to a support for moving it.
